(19) United States
(12) Patent Application Publication
(10) Pub. No.: US 2017/0132845 A1
(43) Pub. Date: May 11, 2017

(54) System and Method for Reducing Virtual Reality Simulation Sickness

(71) Applicant: Dirty Sky Games, LLC, Bellevue, WA (US)

(72) Inventor: Edwin Everman, II, Bellevue, WA (US)

(73) Assignee: Dirty Sky Games, LLC, Bellevue, WA (US)

(21) Appl. No.: 14/937,753

(22) Filed: Nov. 10, 2015

(51) Int. Cl. G06T 19/20; G06F 3/01; G06T 19/00

(52) U.S. Cl. CPC G06T 19/20; G06T 19/006; G06F 3/012; G06F 3/017

(57) ABSTRACT

A method of reducing virtual reality simulation sickness is disclosed. The method starts with rendering a virtual world in a user's field of vision, then detecting and generating a signal indicating a desire to move. Upon detecting the desire to move, a SpiritMove process is conducted, including rendering a SpiritRoom that appears substantially stationary in the field of vision, adjusting a transparency level of the virtual world to appear transparent relative to the SpiritRoom, and simulating movement to the new location over a sequence of frames. During the SpiritMove process, the virtual world appears to move, while the SpiritRoom appears to remain substantially stationary.

### FIELD

The present disclosure relates generally to a system and method for reducing virtual reality simulation sickness.

### BACKGROUND

Virtual reality uses visual stimulus to generate a virtual reality world and simulate physical presence in places in the real world or imagined worlds, and lets the user interact in that world. In the context of the present disclosure, that visual stimulus can be provided to a user, and the user can issue commands to interact with and move through the virtual reality world.

Conventional virtual reality experiences suffer from simulation sickness, which can be caused by a discrepancy between visual and vestibular stimuli. When a conventional virtual reality user moves in the virtual world while remaining stationary in the real, physical world, visible movement of the virtual street, virtual walls, and other virtual objects gives the mental impression that the body is moving, while the inner ear and other proprioceptive senses give the feeling that the body is standing still. This disagreement in the senses can cause simulation sickness.

What is needed is a solution for providing a virtual reality experience that does not suffer from the shortcomings of conventional solutions.

### SUMMARY OF THE INVENTION

A method of reducing virtual reality simulation sickness is disclosed. The method starts with rendering a virtual world in a user's field of vision, then detecting and generating a signal indicating a desire to move. Upon detecting the desire to move, a SpiritMove process is conducted, including rendering a SpiritRoom that appears substantially stationary in the field of vision, rendering a transparent virtual world by adjusting a transparency level of the virtual world to appear transparent relative to the SpiritRoom, and simulating movement to the new location over a sequence of frames. The SpiritMove process includes rendering the transparent virtual world to appear to move, while rendering the SpiritRoom to appear to remain substantially stationary.

### BRIEF DESCRIPTION OF THE DRAWINGS

Various embodiments or examples are disclosed in the following detailed description and the accompanying drawings:

FIG. 1: illustrates an exemplary virtual reality headset for use with an exemplary embodiment of the virtual reality system of the disclosure.

FIG. 2: illustrates an exemplary virtual reality headset being worn on a head according to an exemplary embodiment of the disclosure.

FIG. 3: illustrates a virtual reality system according to an exemplary embodiment of the disclosure.

FIG. 4 illustrates a virtual reality world consisting of a virtual teleconference according to an exemplary embodiment of the disclosure.

FIG. 5: illustrates a virtual reality world consisting of a virtual movie theater according to an exemplary embodiment of the disclosure.

FIG. 6 illustrates an example of a flow for reducing simulation sickness during a move in a virtual reality experience according to various embodiments.

FIG. 7A illustrates a virtual reality world before a move according to an embodiment of the disclosure.

FIG. 7B illustrates a virtual reality world rendered transparent relative to a SpiritRoom rendered in the field of vision during a SpiritMove according to an embodiment of the disclosure.

FIG. 8A illustrates a virtual reality world before a move according to an embodiment of the disclosure.

FIG. 8B illustrates a virtual reality world rendered transparent relative to a SpiritRoom rendered and dimmed in the field of vision during a SpiritMove according to another embodiment of the disclosure.

FIG. 9A illustrates an exemplary virtual reality world during a SpiritMove flow during which the virtual world is rendered transparent relative to a SpiritRoom and dimmed by a constant amount.

FIG. 9B illustrates an exemplary virtual reality world during a SpiritMove flow during which the virtual world is rendered transparent relative to a SpiritRoom and dimmed according to distance.

FIG. 10 illustrates a SpiritRoom according to an exemplary embodiment.

FIG. 11 illustrates an exemplary shader algorithm for rendering a SpiritRoom.

### DETAILED DESCRIPTION

Various embodiments or examples may be implemented in numerous ways, including as a system, a process, or an apparatus. In general, operations of disclosed processes may be performed in an arbitrary order.

A detailed description of one or more embodiments is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

### Virtual Reality Worlds

Virtual reality can be used in video games, where a virtual reality world can be generated to simulate and allow garners to walk around in the game environment. Virtual reality can also be used in urban design, where a virtual reality world can be generated to simulate and allow users to virtually walk around and view architectural and structural designs. Virtual reality worlds can also simulate real properties by generating and allowing users to virtually move around a simulated model of a real property. Virtual reality worlds can also simulate virtual conferences among multiple participants. Additional virtual reality worlds are possible, and the present disclosure is not limited to any one example.

### Virtual Reality Headset

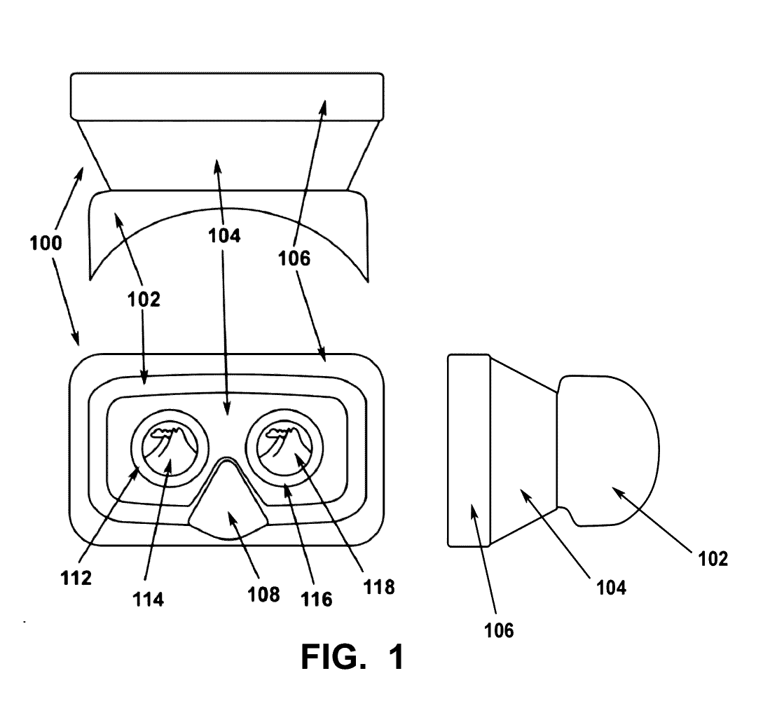

FIG. 1: illustrates an exemplary virtual reality headset for use with an exemplary embodiment of the virtual reality system of the disclosure. Here, virtual reality headset 100 includes face cover 102, optics case 104, video display case 106, nose notch 108, head band 110, left lens case 112, left eye lens 114, right lens case 116, and right eye lens 118. Face cover 102, as would be understood to those of skill, may be made of foam, plastic, polyurethane, or other materials, and be capable of fitting to any face, regardless of ethnicity, age, or gender. Optics case 104 and video display case 106 may also be constructed using plastic, foam, polyurethane, or other materials as is known by a person of skill in the art. In some examples, left lens case 112 and right lens case 116 provide structural support to house left eye lens 114 and right eye lens 118, respectively. In some examples, video display case 106 may house a display which can be used to convey a virtual reality environment and other images to a virtual reality user's field of vision. As used herein, rendering means generating an image from a 2D or 3D model (or models in what collectively could be called a scene file), by executing computer programs. Rendering as used herein may also include conveying the image to a user's field of vision using a display housed within virtual reality headset 100 (FIG. 1), a virtual retina display, a retinal scan display, a retinal projector, a virtual retina projector, or a binocular display implemented using two displays or projecting two images onto a surface, as described below. In some examples, optics case 104 provides two displays, each having 1200 pixel by 1080 pixel displays refreshing at 90 frames per second. Left eye lens 114 and right eye lens 118 in some examples provide a stereoscopic view of one or more displays at the back end of optics case 104.

Virtual reality headset 100 may also include one or more general purpose or specialized processor configured to execute instructions stored on a memory. Such instructions, when executed by the processor, control the virtual reality experience, as well as graphics algorithms and operations, such as z-buffering, shading, dithering, blending, and rendering transparent, to name a few. Instructions may be stored on and loaded from a memory for execution by the general purpose processor or specialized graphics processor. Such memory may include ROM, static or dynamic RAM, FLASH, disc, or SD Card, without limitation. In operation, a processor executes programmatic instructions to control a virtual reality experience and, when a move is desired, to conduct a Spirit Move process to reduce virtual reality simulation sickness according to the disclosure. Examples of virtual reality headsets available in the industry and capable of executing programmatic instructions according to the disclosure include the Oculus Rift, the Sony PlayStation VR, Samsung Gear VR, and HTC Vive (made in partnership with Vive), to name a few.

In operation, a processor or specialized graphics processor may execute code to render a virtual reality environment and other images to a user.

In other examples, virtual reality headset 100 and the above-described elements may be varied and are not limited to those shown and described.

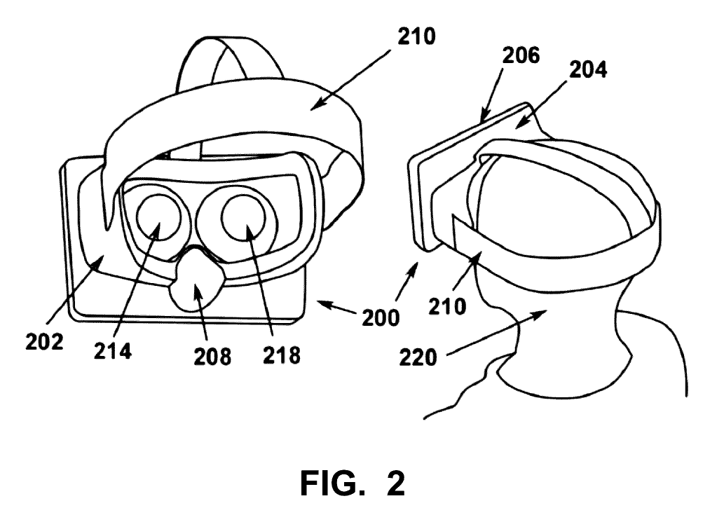

FIG. 2: illustrates an exemplary virtual reality headset being worn on a head according to an exemplary embodiment of the disclosure. Here, virtual reality headset 200 includes face cover 202, optics case 204, video display case 206, nose notch 208, head band 210, left eye lens 214, right eye lens 218, and is worn on a human head 220. In some examples, face cover 202, as would be understood to those of skill, may be made of foam, plastic, or polyurethane, or other material, and be capable of fitting to any adult face, regardless of ethnicity or gender. Optics case 204 and video display case 206 may also be constructed using plastic, foam, polyurethane, or other materials, as is known by a person of skill in the art. In other examples, virtual reality headset 200 and the above-described elements may be varied and are not limited to those shown and described.

### Conveying the Virtual Reality Environment to a User's Field of Vision

In operation, one or more general purpose or specialized processor is configured to convey such rendered images to a user's field of vision. Such rendered images may be conveyed to a user using a display housed within virtual reality headset 100. Such rendered images may also be conveyed to a user using a virtual retina display, also known as a retinal scan display or retinal projector, to draw a raster display directly onto the retinas of a user's eyes. In an alternate embodiment, optics case 204 houses two displays capable of conveying the virtual reality environment to a user's field of vision, with each display having 1080 pixel by 1200 pixel resolution and refreshing at 90 frames per second. Left eye lens 214 and right eye lens 218 in some examples may be used to provide a stereoscopic view of one or more displays at the back end of optics case 204. In some embodiments, the virtual retina projector may be mounted onto virtual reality headset 100, and positioned to scan an image directly on the retina of the user's eye. In alternate embodiments, a virtual reality environment and other images may be conveyed to a user using a virtual reality projector mounted on a table, a wall, a stand, or another static structure, and positioned to scan an image directly on the retina of the user's eye. In alternate embodiments, a virtual reality environment and other images may be conveyed to a user using binocular vision by projecting two images (either at the same time or sequentially) onto a surface, and using specialized glasses to filter what is seen in such way that one of the images enters the left eye and the other enters the right eye. Those of skill will understand that the binocular vision can be used for making the virtual world appear three-dimensional.

### Virtual Reality System

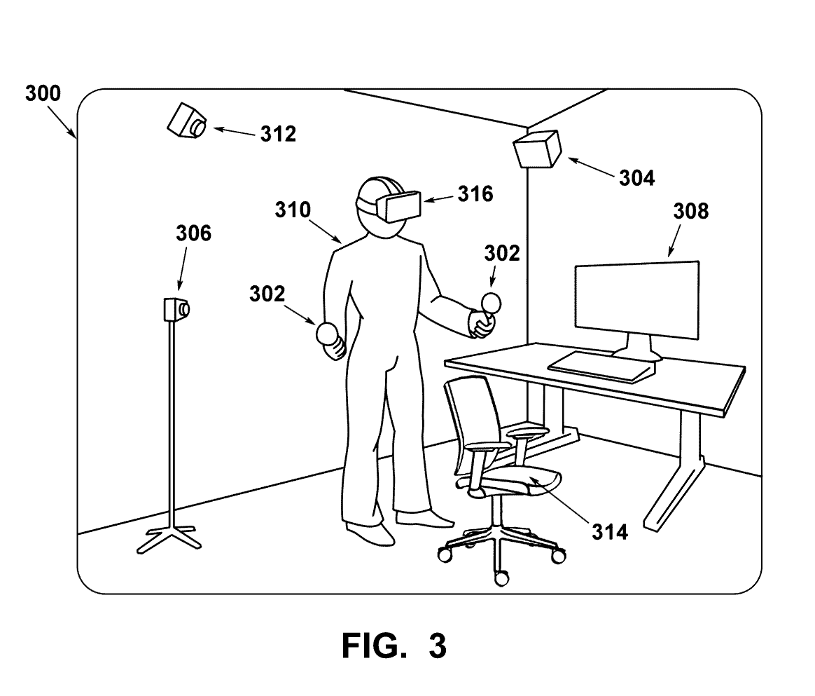

FIG. 3: illustrates a virtual reality system according to an exemplary embodiment of the disclosure. As shown, virtual reality system 300 includes virtual reality headset 316, hand-held input controller 302, headset and controller tracking device 304, room camera 306, personal computer 308, a virtual reality system user 310, body motion capture device 312, and real-world obstacle 314. Virtual reality headset 316 is similar, though not necessarily identical, to virtual reality headset 100 (FIG. 1). Hand-held input controller 302 allows a user to interact with and move in a virtual world, move an avatar, fire weapons, or input other commands. In some examples, body motion capture device 312 may infer user commands by tracking and interpreting the movements and motions of user 310. Body motion capture device 312 may also infer user commands by monitoring a user's waving arms, a user's hand gesture, a user's head position, or a user's stance. In some examples, virtual reality system 300 may also include a microphone and voice recognition capability capable of recognizing audible commands. In some examples, room camera 306 is capable of recording the physical environment or real place where user 310 is engaged in a virtual reality experience.

As shown, personal computer 308 may be used to accept and process inputs and commands from user 310. Personal computer 308 also includes a keyboard, a mouse, a touchscreen, a pointer, or a tablet, any of which could be used by user 310 to enter and issue commands. Personal computer 308 may in some examples, along with or in combination with a 110 processor inside headset 316 or elsewhere inside virtual reality system 300, control the virtual reality experience. Such a processor may also be contained in a mobile computing device, a laptop, a hand-held computing device, or other programmable device, without limitation. As shown, real world obstacle 314 is an office chair, one which user 310 might not see and might therefore run into during a virtual reality experience.

### Virtual Reality Worlds

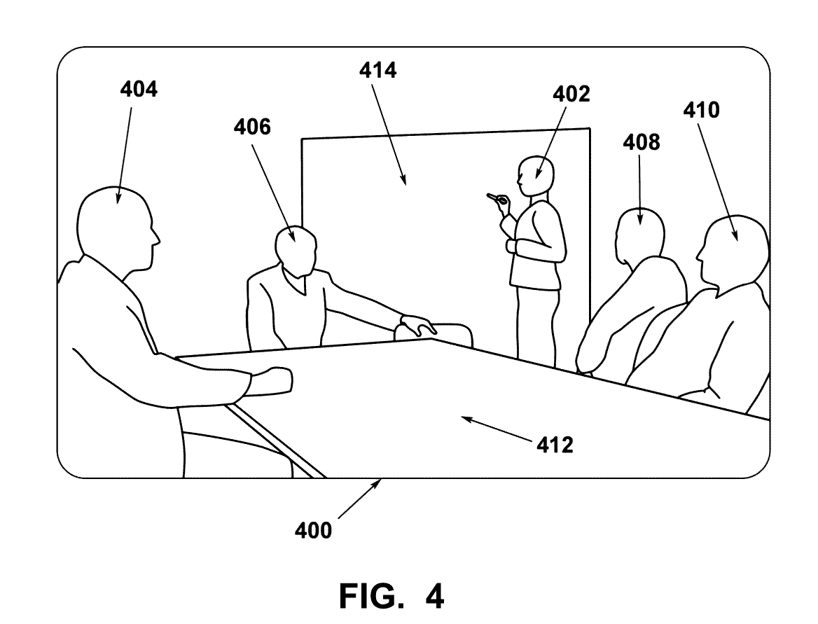

FIG. 4 illustrates a virtual reality world consisting of a virtual teleconference according to an exemplary embodiment. As shown, virtual reality world 400 includes virtual whiteboard 414, virtual reality system user 402 represented as a virtual meeting participant, second virtual meeting participant 404, third virtual meeting participant 406, fourth virtual meeting participant 408, fifth virtual meeting participant 410, and virtual table 412. Virtual meeting participants 402, 404, 406, 408, and 410 may be represented as avatars. Avatars 402, 404, 406, 408, and 410 may in some examples be depicted as three-dimensional avatars with similar characteristics to the real-world persons they represent, having at least one characteristic of the real-world person, such as gender, age, height, weight, hair color, hair style, eye color, and skin tone, to name a few. Avatars 402, 404, 406, 408, and 410 may in other examples include a real picture of a person. Avatars 402, 404, 406, 408, and 410 may in other examples be depicted as 2-dimensional images. Avatars 402, 404, 406, 408, and 410 may in other examples be depicted as three-dimensional models of real people. Virtual table 412 is depicted as a perspective view of a three-dimensional table, but those of skill in the art will understand that virtual table 412 may be depicted as an area on the side of the display where messages, shared documents, and meeting status messages can be shown. Virtual whiteboard 414 may in some examples consist of an electronic scratchpad area where meeting participants can write messages, display documents, or share pictures, without Virtual whiteboard 414 in another exemplary embodiment may display a document to all participants using an editor program, allowing shared collaboration.

In operation, virtual meeting participants 402, 404, 406, 408, and 410 can engage in discussions among the group. In one exemplary embodiment, the virtual meeting participants can communicate using a voice network, a phone, or other telephonic system. In another exemplary embodiment, the virtual meeting participants can communicate electronically using at least one of chat or messaging. In sortie examples, one of the participants will become a primary speaker and have a corresponding avatar approach and control what is displayed on virtual whiteboard 414. In some exemplary embodiments, any one of virtual meeting participants 402, 404, 406, 408, and 410 can request to become the primary speaker. The disclosure is not limited to any particular number of participants; the number may be varied to any number including one or more.

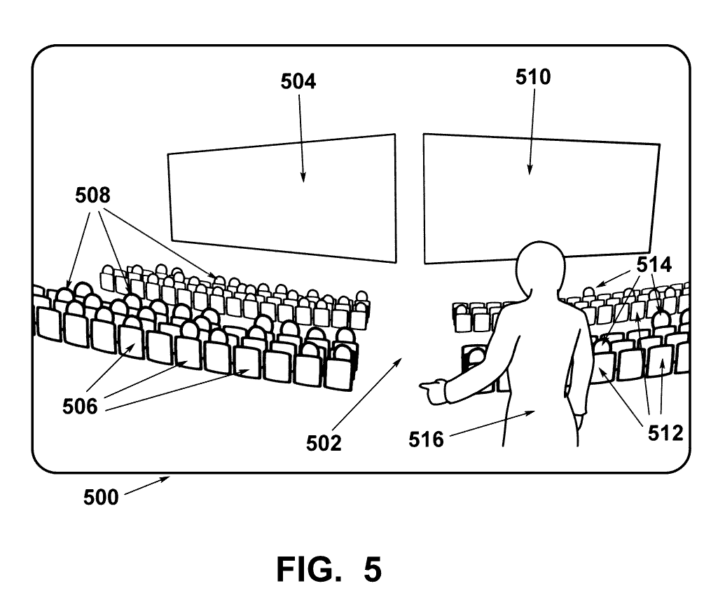

FIG. 5: illustrates a virtual reality world consisting of a virtual movie theater according to an exemplary embodiment. Here, the virtual movie theater 500 includes a virtual aisle 502, first virtual movie screen 504, first virtual theater seats 506, first virtual audience 508, second virtual movie screen 510, second virtual theater seats 512, and second audience 514. As shown, Avatar 516 represents a virtual reality user and may in some examples be depicted as a three-dimensional figure. Avatar 516 may in some embodiments share one or more characteristics of a real user. For example, avatar 516 may exhibit the same gender, hair color, skin color, height, body proportions, or wardrobe as a real user. As those of skill will understand, the representations of avatar 516 are not limited to a three-dimensional human; a suitable avatar can be depicted as an animal, an object, a three-quarters view, a torso view, a first-person view, or a two-dimensional character, to name a few examples. In an alternate virtual reality experience consistent with the disclosure, avatar 516 will not be shown.

In one exemplary embodiment, movie screens 504 and 510 show different movies, and a user can opt to watch one of the movies or the other.

### Virtual Reality Algorithm for Reducing Simulation Sickness

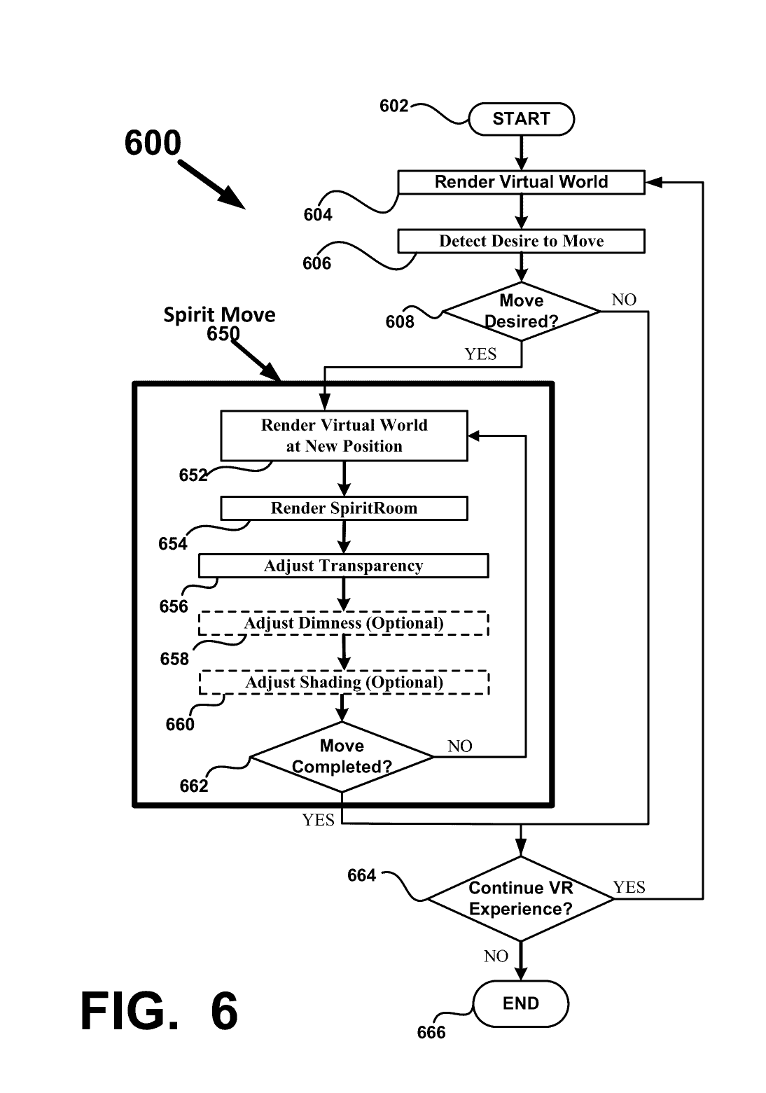

FIG. 6 illustrates an example of a flow for reducing simulation sickness during a move in a virtual reality experience according to various embodiments. As shown, exemplary flow 600 starts at 602, renders a virtual world on the display at 604, detect whether the user desires to move at 606, and, if so, initiates a Spirit Move at 608. Exemplary flow 600 may in some examples be implemented by programmatic instructions executed by a processor housed in virtual reality headset 100 (FIG. 1), or 200 (FIG. 2), or elsewhere within virtual reality system 300 (FIG. 3). Those of skill will understand that embodiments other than a processor in the headset may be used to perform flow 600; for example, flow 600 may be implemented as programmable instructions to be executed by a handheld computing device, a personal computer, or a gaming console.

In operation, a user begins a virtual reality experience at starting point 602. In the illustrated embodiment, a virtual reality world is rendered at box 604. In some examples, a user may interact with this virtual world, including by examining objects, touching objects, interacting with other participants, or moving short distances, to name a few. In box 606, flow 600 calls for detecting a desire to move. In one embodiment of detection 606, a signal will be received from a handheld controller indicating that a user actuated controller 302 (FIG. 3) in a particular way to indicate a desire to move. For example, a user can indicate a desire to move by pressing and holding a button, or clicking a button twice, or pushing a control stick up, or by pressing left and right buttons at the same time. In an alternate embodiment of detection 606, virtual reality system 300 (FIG. 3) will include a microphone and a processor, which together will detect an audible indication of a desire to move and generate a signal indicating a desire to move. For example, the user may voice a command “Move Forward” or “Move Left” or “Move Right,” to name a few. In an alternate embodiment of detection 606, a user may indicate a desire to move by pressing one or more keys on a keyboard, a mouse, a touchscreen, or a tablet, without limitation. In an alternate embodiment of detection 606, any one or more of a spatially tracked input controller 302 (FIG. 3), a tracking device 304 (FIG. 3), a room camera 306 (FIG. 3), or a body motion capture device 312 may include an accelerometer or other motion tracking device to monitor a user's body motion, and, upon detecting a predetermined motion, generate a signal indicating a desire to move. For example, a user's waving arms, a user's hand gesture, a user's head position, and a user's stance can be monitored to detect a particular motion indicating a desire to move. In another embodiment, as is known by those of skill, a user may wear a specialized glove that includes electronics capable of detecting a user's hand gestures, with detection of a particular hand gesture indicating a desire to move. Alternate ways to indicate a desire to move are possible, and the disclosure is not limited to any particular one.

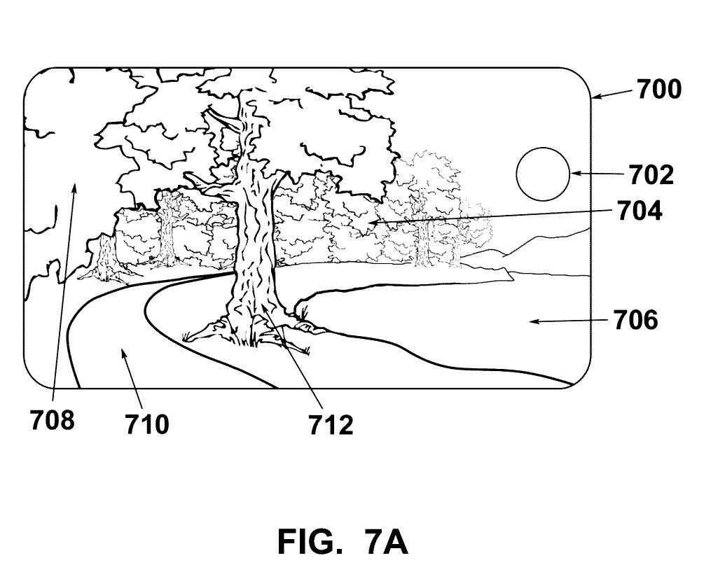

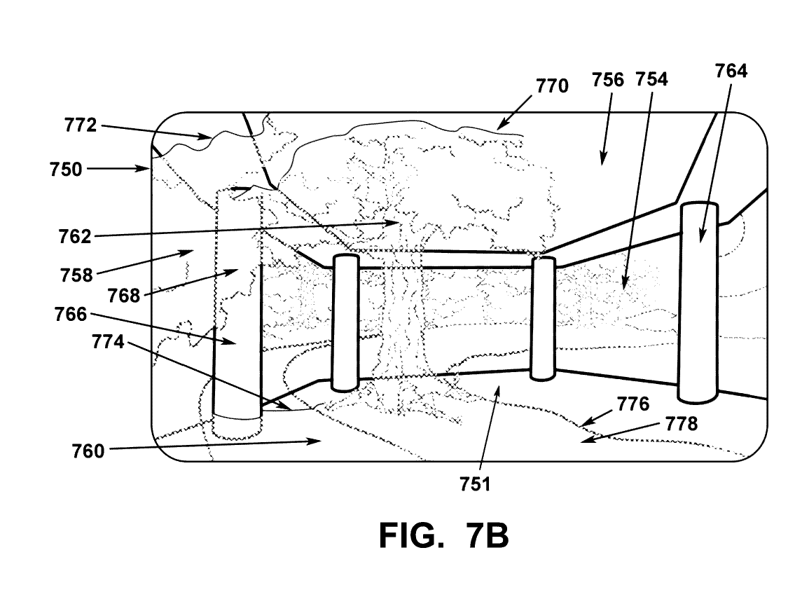

Upon detecting a desire to move 606 and determining that a move is desired at 608, flow 600 initiates a SpiritMove process 650. SpiritMove 650 includes rendering a virtual world at a new position at box 652, rendering a SpiritRoom (See SpiritRoom in FIGS. 7B, 8B, 9A, and 9B, and corresponding discussion, below) at box 654, adjusting transparency at box 656, optionally adjusting dimness at box 658, and optionally adjusting shading at box 660. In some examples, rendering the virtual world at box 652 swill include resolving visibility of various objects and layers using z-buffering, as is understood by those of skill. In some embodiments, the virtual world will be rendered to be transparent at box 656. The particular percentage of transparency is not limited to any particular value.

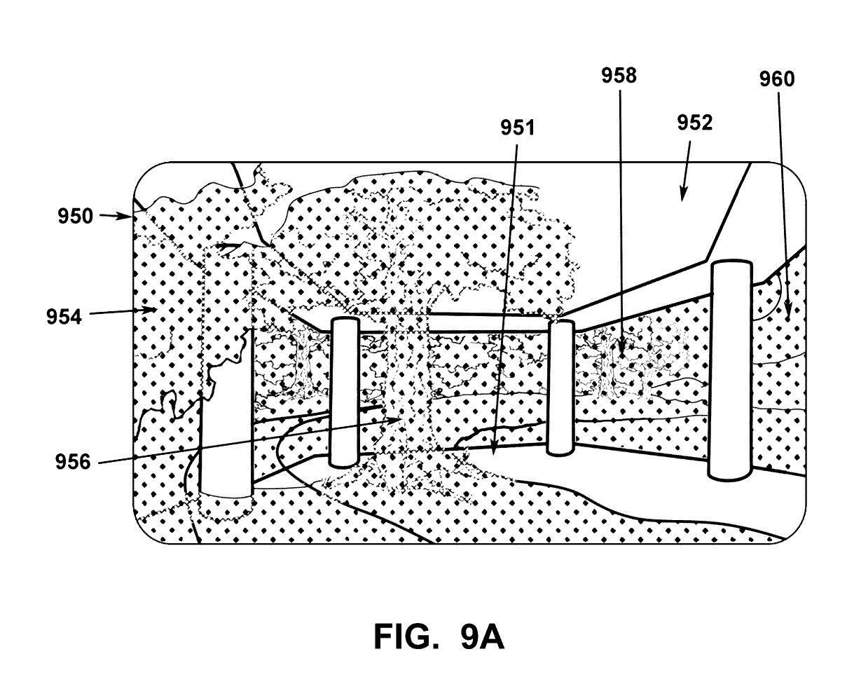

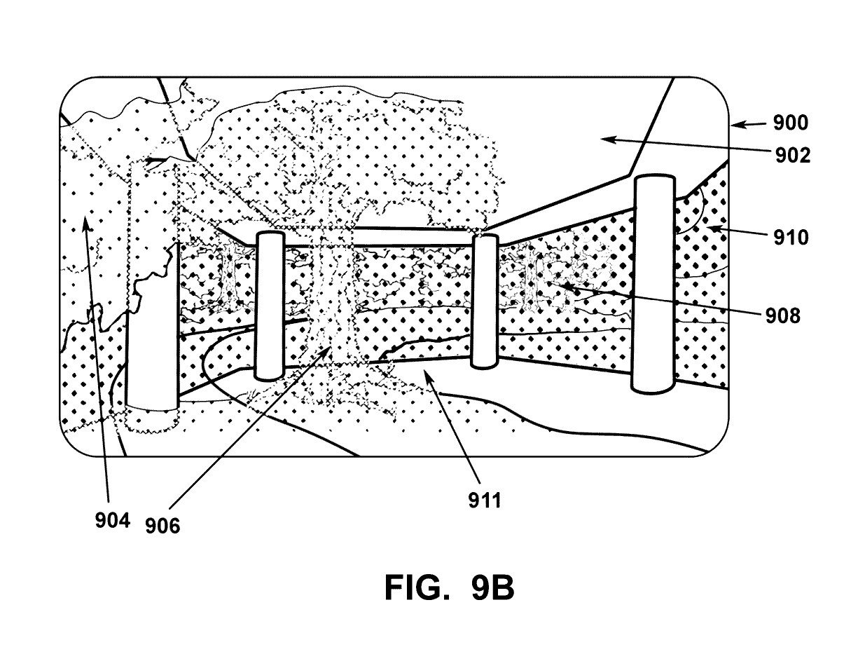

A SpiritRoom is generated in box 654 of SpiritMove 650. In some examples, a SpiritRoom can be a three-dimensional structure depicting a virtual room in which the user appears to be standing. The virtual room in such a view may include a floor, a ceiling, windows, doors, or other architectural features, each of which can appear to be disposed at varying distances from the user. In other examples, the SpiritRoom may be shown as a virtual colonnade in which the user appears to be standing (See FIGS. 7B, 9A, 9B, and corresponding discussion, below). In another example, the SpiritRoom may be a virtual structure having dimensions of a scale that is similar to the dimensions of the virtual world. For example, as shown and discussed below with respect to FIG. 7B, SpiritRoom 751 (FIG. 7B) may be so large that tree 762 (FIG. 7B) falls within the bounds of SpiritRoom 751 (FIG. 7B) while distant trees 754 (FIG. 7B) fall outside the bounds of SpiritRoom 751 (FIG. 7B). Those of skill will understand that geometries of the SpiritRoom may be varied.

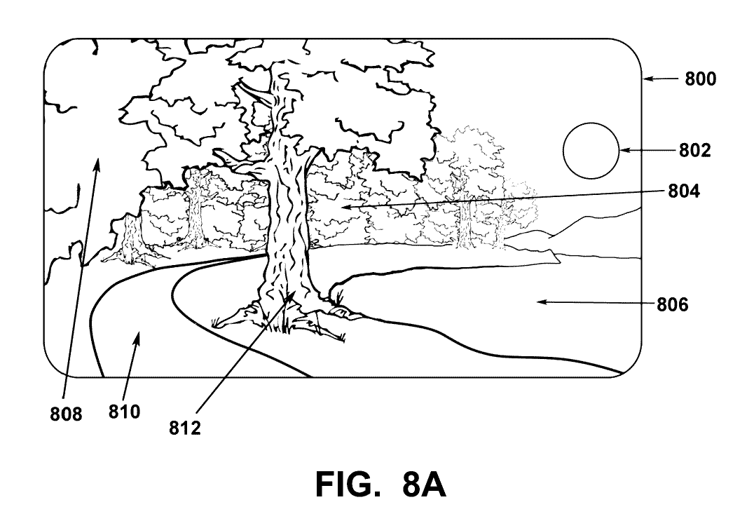

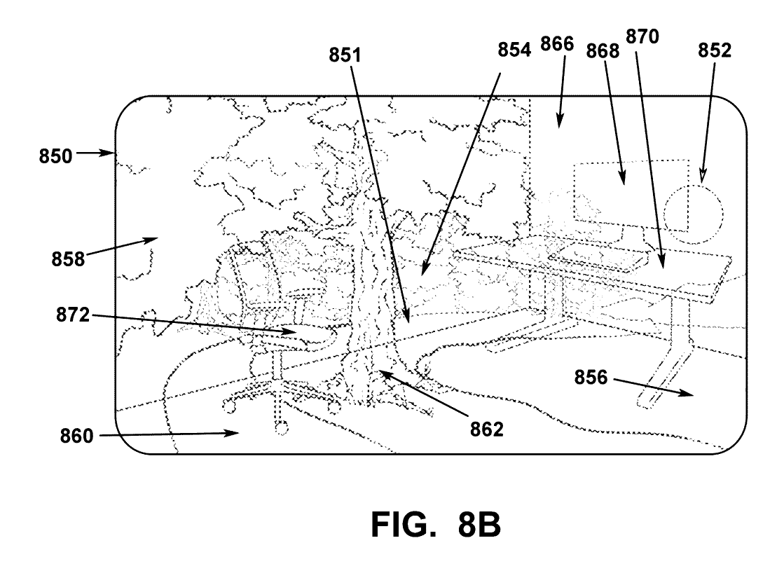

In still other examples, the SpiritRoom may be a depiction of the actual room in which the user is standing. In an exemplary embodiment, a head-mounted camera worn on a user's head may generate a recording of the actual room, and the recording can be used as a model for a SpiritRoom (See FIG. 8B, and corresponding discussion, below). In an alternate embodiment, headset and controller tracking device 304 (FIG. 3) may be adapted to generate a recording of the actual room for use in crating a model of the SpiritRoom. In an alternate embodiment, room camera 306 (FIG. 3) may be used to generate a recording of the actual room for use in generating a model of the SpiritRoom. In an alternate embodiment, body motion capture device 312 (FIG. 3) may be used to generate a recording of the actual room for use in generating a model of the SpiritRoom. When a camera is used, the SpiritRoom may also include actual objects that are in the actual room, such as the chair 314 (FIG. 3), such that the virtual reality user 310 (FIG. 3) may be aware of and able to avoid the object.

In a further exemplary embodiment, a model of the actual room may be generated and used without the use of any camera or video; those of skill in the art will understand that such a model may be generated manually by entering dimensions and architectural features of the actual room, as well as the location of one or more objects in the room. In a further exemplary embodiment, a physical room or space for experiencing the virtual reality experience may be implemented, and a model of that physical room may be used to generate the SpiritRoom.

In operation of SpiritMove 650, motion in the virtual world will be simulated over a sequence of frames by rendering the virtual world at 652 at new positions, and simulating movement during the sequence by adjusting the position of the virtual world. SpiritMove 650 checks at box 662 whether a move has been completed, and, if not, returns to rendering the virtual world at a new position at 652. In an exemplary embodiment, SpiritMove 652 may take 3.0 seconds over a sequence of 270 frames, or 270 occurrences of box 652, to complete.

In operation, during SpiritMove 650, the virtual world will appear to be moving, while the SpiritRoom will appear to remain substantially stationary. By controlling the level of transparency of the virtual world in box 656, SpiritMove 650 can draw attention to the substantially stationary SpiritRoom, and thereby reduce the occurrence or severity of simulation sickness by reducing the discrepancy between a user's visual senses and vestibular senses. In other words, during SpiritMove 650, a user will be physically stationary, as will be indicated by vestibular senses. At the same time, the user's vision will be substantially drawn to the SpiritRoom, which will appear to remain substantially stationary, so the visual senses similarly give the impression of being stationary. In some embodiments, the transparency of the SpiritRoom may also be adjusted in box 656, so as to draw the user's vision to the SpiritRoom. If the SpiritRoom entirely occupies the field of vision, the SpiritRoom may also be rendered to be transparent, so as to allow the virtual world to be seen. In one embodiment, the virtual world transparency can be set to 90% relative to the SpiritRoom during a SpiritMove, which may draw the user's eye mostly to the SpiritRoom, while still allowing the user to view and control movement of the virtual world. In other embodiments, the virtual world transparency can be set to 65%. In either case, because the user's eye is drawn to the substantially stationary SpiritRoom during the move, the user's visual senses and vestibular senses will be substantially in accord, and simulation sickness will be reduced.

In an alternate embodiment, the SpiritRoom may be made to appear stationary by compensating for actual movements of the user. An accelerometer, a tracking device, or other motion sensor may track the user's movements, and adjust the apparent position of the virtual SpiritRoom to compensate for the user's motion. For example, if the user's head is actually tilting to the left or right during a SpiritMove, the position of the virtual SpiritRoom may be adjusted to compensate for that motion.

Although SpiritMove 650 in FIG. 6 shows rendering the virtual world 652 before rendering the SpiritRoom 654, the present disclosure is not so limited and the order of steps may be varied. For example, the SpiritRoom may be rendered before the Virtual World.

In addition to adjusting the transparency of the virtual world in box 656, SpiritMove 650 may optionally adjust the dimness of the virtual world, the SpiritRoom 660, or both at box 658. Adjusting dimness at 658 may also reduce simulation sickness during a move by drawing a user's eye to the SpiritRoom.

In addition to adjusting the transparency of the virtual world in box 656, SpiritMove 650 may also optionally adjust the shading of the virtual world, the SpiritRoom or both at box 660. Adjusting shading at 660 may also reduce simulation sickness during a move by drawing a user's eye to the SpiritRoom.

FIG. 7A illustrates a virtual reality world before a move according to an embodiment of the disclosure. Here, virtual reality world 700 includes virtual sun 702 in the background, virtual trees 704 in the background, virtual lake 706, virtual bush 708 in the foreground, virtual path 710 leading from the foreground to the background, and virtual tree 712 in the foreground.

In operation, flow 600 (FIG. 6) may be used with FIG. 7A to provide a virtual reality experience with reduced occurrence or severity of simulation sickness. Starting at 602 (FIG. 6), the virtual world shown in FIG. 7A may be rendered at 604 (FIG. 6) and conveyed to a user's field of vision using a display housed within virtual reality headset 100 (FIG. 1), a virtual retina display, a retinal scan display, a retinal projector, a virtual retina projector, or a binocular display implemented using two displays or projecting two images onto a surface, as described above. The virtual experience may continue until a desire to move is detected at 606 (FIG. 6) and a signal indicating a desire to move is generated at 608 (FIG. 6).

FIG. 7B illustrates a virtual reality world rendered transparent relative to a SpiritRoom during a SpiritMove according to an embodiment. Here, virtual reality world 750 has been rendered transparent as part of an embodiment of the SpiritMove method of the disclosure. Virtual reality world 750 here is shown being rendered to include SpiritRoom 751, area 754 of the transparent visual world disposed further away than the SpiritRoom, area 756 of the SpiritRoom disposed closer than the bounds of SpiritRoom 751, transparent virtual bush 758 disposed closer than the bounds of virtual SpiritRoom 751, transparent virtual path 760 disposed closer than the bounds of SpiritRoom 751, transparent tree 762 disposed closer than tile bounds of SpiritRoom 751, SpiritRoom column 764 dispose closer than any virtual world element, portion 766 of the SpiritRoom not obscured by virtual world elements, portion 768 of SpiritRoom 751 disposed behind and obscured by virtual world elements, seam 770 where transparent virtual world tree 762 cuts through SpiritRoom 751, seam 772 where transparent virtual bush 758 cuts through SpiritRoom 751, seam 774 where transparent virtual path 760 cuts through SpiritRoom 751, transparent virtual world hill silhouette 776, seam 778 where transparent virtual hill 776 cuts through SpiritRoom 751 hidden behind 776.

FIG. 8A illustrates a virtual reality world before a SpiritMove according to an embodiment of the disclosure. Here, virtual reality world 800 is shown before a SpiritMove, and includes virtual sun 802 in the background, virtual trees 804 in the background, virtual lake 806, virtual bush 808 in the foreground, virtual path 810 leading from foreground to background, and virtual tree 812 in the foreground.

In operation, flow 600 (FIG. 6) may be used with FIG. 8A to provide a virtual reality experience with reduced occurrence or severity of simulation sickness. Starting at 602 (FIG. 6), the virtual world shown in FIG. 8A may be rendered by a processor at 604 (FIG. 6) and conveyed to a user's field of vision using a display housed within virtual reality headset 100 (FIG. 1), a virtual retina display, a retinal scan display, a retinal projector, a virtual retina projector, or a binocular display implemented using two displays or projecting two images onto a surface, as described above. The virtual experience may continue until a desire to move is detected at 606 (FIG. 6), and a signal is generated at 608 (FIG. 6) indicating a desire to move.

After receiving a signal indicting a desire to move at 608, flow 600 initiates a SpiritMove process 650. As shown in FIG. 8B, SpiritMove 650 includes rendering a virtual world at a new position at 652, rendering a SpiritRoom at 654, and adjusting the transparency of the virtual world at 656. In some examples, rendering the virtual world at box 652 will include resolving visibility of various objects and layers using z-buffering.

FIG. 8B illustrates a virtual reality world rendered transparent relative to a SpiritRoom rendered and dimmed in the field of vision during a SpiritMove according to an exemplary embodiment. As shown, transparent virtual world 850 includes real-world SpiritRoom 851, virtual sun 852 seen through office wall 866, virtual trees 854 seen in a distance through office wall 866, virtual lake 856 seen through office wall 866, transparent virtual bush 858 seen in front of office wall 866, transparent virtual path 860 seen both in front of and behind office wail 866, transparent virtual tree 862 seen both in front and behind office wall 866, transparent real-world room wall 866, transparent real-world computer 868, transparent real-world table 870, and transparent real-world chair 872.

In some exemplary embodiments, real-world SpiritRoom 851 may be generated using; a head-mounted camera worn on a user's head to record the room, and to generate a model of real-world SpiritRoom 851 using the recording. In an alternative exemplary embodiment, headset and controller tracking device 304 (FIG. 3) may be adapted to generate a recording of the actual room for use in generating a model for use as real-world SpiritRoom 851. In an alternative exemplary embodiment, room camera 306 (FIG. 3) may be used to generate a recording of the actual room for use as real-world SpiritRoom 851. In an alternative exemplary embodiment, body motion capture device 312 (FIG. 3) may be used to generate a recording of the actual room for use in generating a model for use as SpiritRoom 851. In another exemplary embodiment, the real physical environment can be recorded by a camera, such as a camera mounted on headset 316 (FIG. 3), and the real physical world can be used as a SpiritRoom.

In a further exemplary embodiment, a model of the actual room may be generated and used without the use of any camera or video. Those of skill in the art will understand that a model of the real world environment could be modeled and rendered as SpiritRoom 851. Such a model may be generated manually by entering dimensions and architectural features of the actual room, as well as the location of one or more objects in the room. In a further exemplary embodiment, a physical room or space for the virtual reality experience may be implemented, and a model of that physical room may be used to generate real-world SpiritRoom 851.

FIG. 9A illustrates an exemplary virtual reality world during a SpiritMove flow during which the virtual world is rendered transparent relative to a SpiritRoom and dimmed by a constant amount. FIG. 9A illustrates a virtual reality world 950 rendered transparent and dimmed to varying degrees relative to a SpiritRoom 951 rendered in the field of vision during a SpiritMove according to another embodiment of the disclosure. Here, virtual reality world 950 is shown with constant dimming during a SpiritMove, and includes foreground bush 954, midground tree 956, background trees 958, and background sky 960 shown in the virtual world.

FIG. 9B B illustrates an exemplary virtual reality world during a SpiritMove flow during which the virtual world is rendered transparent relative to a SpiritRoom and dimmed according to distance. FIG. 9B illustrates an exemplary implementation of a SpiritMove 650 (FIG. 6), including rendering a virtual world at a new position at 652 (FIG. 6), rendering a SpiritRoom at 654 (FIG. 6), and adjusting the transparency of the virtual world at 656 (FIG. 6). FIG. 9B further illustrates a dimmed virtual world, the dimming taking place during optional step 658 (FIG. 6). FIG. 9B illustrates a virtual reality world rendered transparent and dimmed to varying degrees relative to a SpiritRoom rendered in the field of vision during a SpiritMove according to an exemplary embodiment of the disclosure. As shown, virtual reality world 900 includes SpiritRoom 902 with no dimming, foreground bush 904 in the virtual world with mildest dimming, midground tree 906 shown in the virtual world with light dimming, background trees 908 shown in the virtual world with medium dimming, and background sky 910 with heavy dimming.

In some embodiments, SpiritRoom 751 (FIG. 7), 851 (FIG. 8B), or 951 (FIG. 9A) could contain software elements, such as user interfaces, messages, or advertising without cluttering up the virtual world. These elements would only be seen awhile the SpiritRoom is active, keeping the virtual world uncluttered when the SpiritRoom is not active.

In some embodiments, SpiritRoom 751 (FIG. 7), 851 (FIG. 8B), or 951 (FIG. 9A) could be active at all times instead of appearing only during movement.

In an alternate embodiment, SpiritRoom 751 (FIG. 7), 851 (FIG. 8B), or 951 (FIG. 9A) could be shared with multiple users who are simultaneously engaged in a virtual reality experience, allowing for easy person-to-person interaction even if the users are far away from each other in the virtual world, or not even present in the same virtual worlds.

In an alternate embodiment, operation of the virtual world as depicted in FIG. 9B, the dimming and transparency of the moving virtual world may draw a user's eyes to the stationary SpiritRoom, so that both the visual senses and the vestibular senses give the impression of being stationary, thereby reducing the occurrence or severity of simulation sickness.

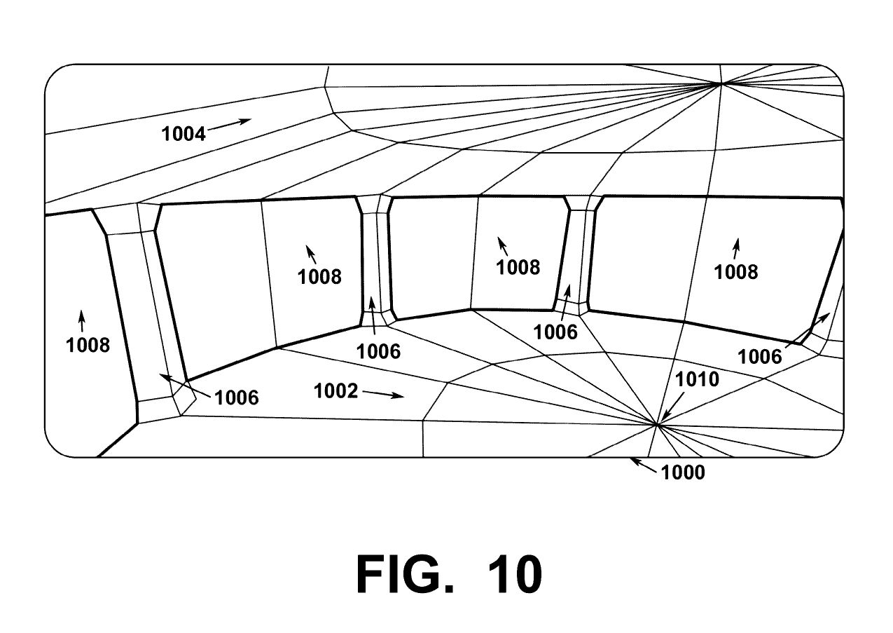

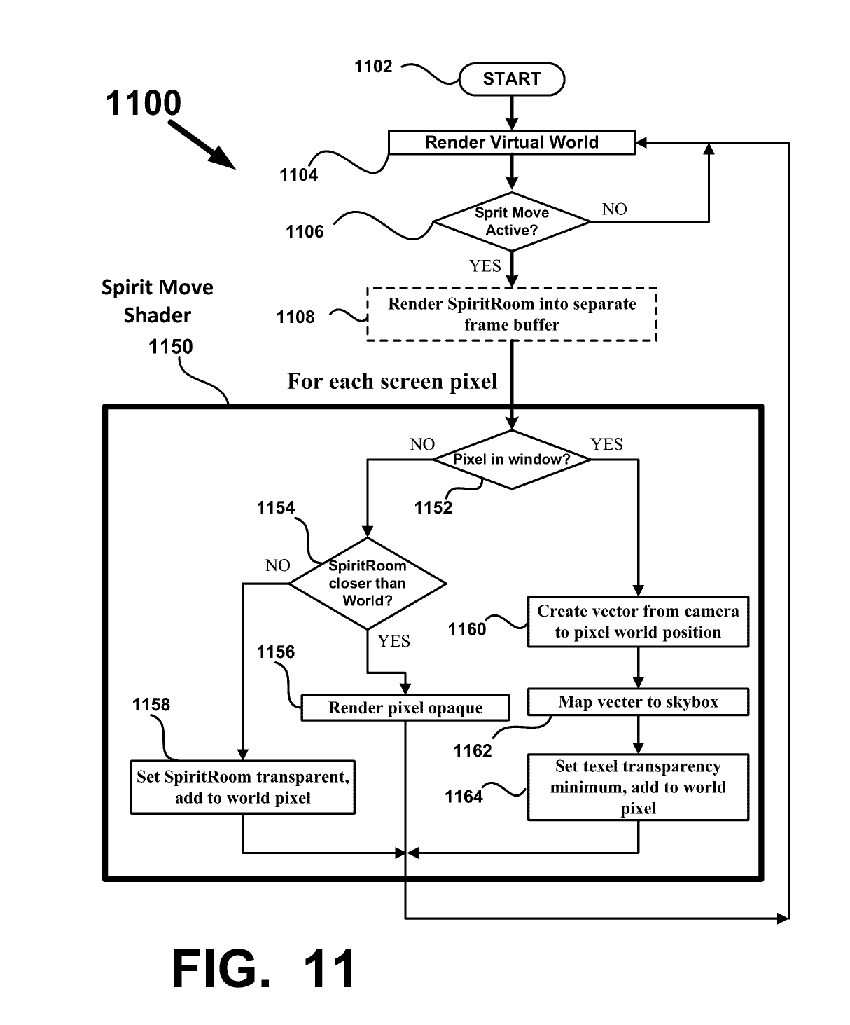

FIG. 10 illustrates a SpiritRoom according to an exemplary embodiment. As shown, SpiritRoom 1000 includes SpiritRoom Floor Polygons 1002, SpiritRoom Ceiling Polygons 1004, SpiritRoom Pillar Polygons 1006, SpiritRoom Window Polygons 1008, and Viewer's Location 1010. SpiritRoom 1000 in the illustrated embodiment is implemented as an enclosed polygonal mesh with no holes in the faces. (As used herein and understood by those of skill, vertices connect to make edges, edges connect to make faces, and faces connect to make meshes.) SpiritRoom 1000 in the illustrated embodiment substantially completely encloses the user and is disposed at a position relative to the user's location 1010. The polygons that make up the area that can be seen through Window Polygons 1008 are indicated using a UV texture mask. If the mask value for a texel is 1, the mesh face should appear as normal geometry, but if the mask value for a texel is 0, it is considered see-through, and should appear as a background far away at infinity. In the exemplary shader algorithm illustrated in FIG. 11 and discussed below, the UV texture mask is used to resolve the question in step 1152.

FIG. 11 illustrates an exemplary shader algorithm for rendering a SpiritRoom. Since the viewer is completely enclosed by the SpiritRoom mesh, every screen pixel will have a corresponding SpiritRoom pixel. There is no vector projected from the two viewing cameras (left eye and right eye) that doesn't intersect the SpiritRoom mesh. The virtual world is first rendered at 1104 without the Spirit Room visible. If SpiritMove is active at 1106, the SpiritRoom will be rendered. In an optional step 1108, the SpiritRoom mesh is rendered into its own frame buffer separate from the main display buffer to allow elements of the SpiritRoom to be in front of other SpiritRoom elements to occlude them from view or allow room environment lighting to be completely different from that used to light the virtual world. However if the SpiritRoom mesh has no overlapping geometry (i.e. all vectors from the camera to any spot on the SpiritRoom hits one and only one polygon), then the SpiritRoom pixels can be rendered directly into the main frame buffer. In some embodiments, each pixel of the screen pixel is displayed using a material shader. In particular, areas that the player should see the world through, such as windows, doorways, or spaces between pillars are marked in a UV texture mask. That mask is checked in step 1152 to determine if the area is open (e.g. window) or closed (e.g. floor, pillar, or ceiling). For unmasked areas, the pixel shader checks the screen depth for each pixel of the SpiritRoom rendered in step 1154 (As used herein, screen depth refers to the distance from the viewing plane to the rendered pixel in world space.). If the pixel of the SpiritRoom mesh is closer than the screen depth for that pixel, it is rendered fully opaque in step 1156, overwriting the world pixel (i.e. the player directly sees the room geometry at that pixel). If the pixel of the SpiritRoom mesh is farther than the screen depth for that pixel, it is rendered at the world transparency value in step 1158 (i.e. the player sees the world geometry as transparent on top of the room geometry). As used herein, the “world transparency value” is similar to the transparency level described above with respect to box 654 of flow 600 illustrated in FIG. 6.

For masked window areas that represent a view to infinity, a vector is calculated from the camera to the pixel location in world space of the window face (i.e. polygon) for that pixel in step 1160. The vector is used to map to a spherical skybox texture in step 1162. In step 1164, the skybox texel is set to the same transparency value used for world geometry in step 1156 (i.e. the players sees the world geometry as transparent on top of a skybox, which that in stereoscopic views is perceived to be disposed at infinite distance behind any transparent virtual world geometry). Optionally, the transparency could be set according to the depth of the world pixel, making the world geometry more transparent the further away it is.

What is claimed:

1. A method of reducing virtual reality simulation sickness, the method comprising:
rendering a virtual world in a field of vision;
detecting a signal indicating a desire to move to a new location of the virtual world;
upon detecting the signal, performing a SpiritMove method comprising the steps of:
rendering a SpiritRoom in the field of vision,
adjusting a transparency level of the virtual world, the transparency level being selected such that the virtual world appears transparent relative to the SpiritRoom;
simulating movement to the new location over a sequence of frames by moving the position of the virtual world during the sequence of frames while rendering the SpiritRoom to give the impression that it remains substantially stationary during the sequence of frames.

2. The method of claim 1, wherein rendering the SpiritRoom to give the impression that it remains substantially stationary comprises substantially compensating for movement of a virtual reality headset.

3. The method of claim 1 wherein the transparency level varies from 60% to 95%.

4. The method of claim 1, wherein performing the SpiritMove method further comprises dimming a brightness of the SpiritRoom, the virtual world, or both.

5. The method of claim 1, wherein detecting the signal indicating a desire to move comprises receiving a control signal from a user input device.

6. The method of claim 1, wherein detecting the signal indicating a desire to move comprises detecting an audible command.

7. The method of claim 1, wherein detecting the signal indicating a desire to move comprises detecting a gesture.

8. The method of claim 1, wherein detecting the signal indicating a desire to move comprises predicting the desire to move and automatically generating the signal.

9. The method of claim 1, further comprising:
detecting a signal indicating completion of the move to the new location;
discontinuing display of the SpiritRoom in the field of vision;
adjusting the transparency level of the virtual world to an original level.

10. The method of claim 1, wherein the SpiritRoom comprises architectural structures.

11. The method of claim 1 wherein the SpiritRoom substantially completely occupies the field of vision.

12. The method of claim 1, wherein rendering the SpiritRoom comprises receiving visual images from a camera and rendering a view of an actual physical environment in which a virtual reality headset is located.

13. The method of claim 13 wherein the SpiritRoom further shows physical objects that are located in the actual physical environment.

14. The method of claim 1, wherein rendering the SpiritRoom comprises building and maintaining a model of an actual physical environment in which a virtual reality headset is located, and rendering a view of the model in the field of vision.

15. The method of claim 14 wherein the SpiritRoom further shows physical objects that are located in the actual physical environment.

16. The method of claim 1 wherein the virtual world comprises one or more of a shopping mall, a movie theater, or a real property.

17. The method of claim 1, wherein performing the SpiritMove method further comprises shading the SpiritRoom, the virtual world, or both.

18. The method of claim 1 wherein the virtual world comprises a virtual reality teleconference and a virtual white board.

19. A virtual reality system comprising:
a processor configured to render a virtual reality environment and a SpiritRoom;
a means for conveying the virtual reality environment to a user's field of vision;
a motion sensor configured to detect a motion of the user;
the processor configured to execute instructions to perform the steps of:
rendering a virtual world;
detecting a signal indicating a desire to move to a new location of the virtual world;
upon detecting the signal, performing a SpiritMove process comprising rendering a SpiritRoom;
rendering a transparent virtual world, the transparent virtual world being rendered by applying a transparency level to the virtual world;
operating the means for conveying to convey the SpiritRoom and the transparent virtual world to the field of vision,
simulating movement to the new location over a sequence of frames, the position of the transparent virtual world being rendered and conveyed to appear to be moving in the field of vision during the sequence of frames while the SpiritRoom is rendered and conveyed to appear to remain substantially stationary relative to the motion of the user during the sequence of frames.

20. A non-transitory computer-readable medium storing computer instructions that, when executed by a processor, control a virtual reality system to perform the steps of:
monitoring a signal from a motion detector;
rendering and displaying a virtual world in a field of vision of a user;
detecting a signal indicating a desire to move to a new location of the virtual world;
upon detecting the signal, performing a SpiritMove comprising the steps of:
rendering a SpiritRoom in the field of vision,
adjusting a transparency level of the virtual world, the transparency level being selected such that the virtual world appears transparent relative to the SpiritRoom;
simulating movement to the new location over a sequence of frames, the position of the virtual world moving in the field of vision during the sequence of frames while the position of the SpiritRoom appears to remain substantially stationary relative to the signal from the motion detector during the sequence of frames.
